(19) United States
(12) Patent Application Publication
(10) Pub. No.: US 2025/0034353 A1
(43) Pub. Date: Jan. 30, 2025

(54) RUBBER COMPOSITION

(71) Applicant: Compagnie Generale Des Etablissements Michelin, Clermont-Ferrand (FR)

(72) Inventors: Guillaume PIBRE, Clermont-Ferrand (FR); Thomas FERRAND, Clermont-Ferrand (FR)

(21) Appl. No.: 18/712,128

(22) PCT Filed: Nov. 14, 2022
(86) PCT No.: PCT/EP2022/081699

§ 371 Date: May 21, 2024

(30) Foreign Application Priority Data
Nov. 22, 2021 (FR) 2112340

(51) Int. Cl. C08K 3/36; B60C 1/00; C08K 5/548

(52) U.S. Cl. CPC C08K 3/36; B60C 1/0016; C08K 5/548

(57) ABSTRACT

A rubber composition that comprises a highly saturated diene elastomer which is a copolymer of ethylene and of a 1,3-diene containing ethylene units which represent more than 50 mol % of the monomer units of the copolymer, a vulcanization system, a silane coupling agent and a reinforcing filler that contains a silica made hydrophobic prior to its use in the rubber composition by treatment with a blocked or non-blocked mercaptosilane, and a hydrophilic silica, is provided. Such a composition has improved curing properties whilst maintaining the compromise of property between stiffness and hysteresis.

### CROSS-REFERENCE TO RELATED APPLICATIONS

This U.S. patent application is a national phase entry of PCT Patent Application No. PCT/EP2022/081699 filed Nov. 14, 2022, which claims priority to French Patent Application No. FR2112340 filed Nov. 22, 2021, the entire contents of which are incorporated herein by reference in their entirety.

### BACKGROUND

### 1. Technical Field

The field of the present invention is that of rubber compositions which comprise a silica and a highly saturated diene elastomer and which are intended in particular for use in the manufacture of tires.

### 2. Related Art

Rubber compositions reinforced with a silica and comprising a highly saturated diene elastomer are known from documents WO 2014114607 A1 and WO 2018224776 A1. The highly saturated diene elastomer is a copolymer of ethylene and a 1,3-diene such as 1,3-butadiene and has the particularity of containing more than 50 mol % of ethylene units. Due to its high ethylene content and its low diene unit content of less than 50 mol %, it differs greatly from diene elastomers that are conventionally used in rubber compositions and which generally contain more than 50 mol % of diene units, such as polybutadienes, polyisoprenes and copolymers of 1,3-butadiene or isoprene and of styrene. In particular, it has the particularity of giving a rubber composition a different compromise of properties between stiffness and hysteresis which conveys an advantageous performance compromise between wear resistance and rolling resistance.

Highly saturated elastomers which contain more than 50 mol % of ethylene unit have the distinguishing feature of vulcanizing according to slower kinetics than highly unsaturated elastomers which contain more than 50 mol % of diene units. Longer residence times in the curing presses are thus necessary to vulcanize rubber compositions containing highly saturated diene elastomers, which results in a longer press occupation time by a rubber composition, which has the effect of reducing the productivity of tire manufacturing sites.

There is thus a need to reduce the in-press time of such rubber compositions while retaining the particular compromise of properties between the stiffness and the hysteresis of these rubber compositions.

### SUMMARY

The inventors have discovered that the combined use of a hydrophilic silica and of a silica made hydrophobic beforehand in such rubber compositions makes it possible to satisfy this need.

Thus, the invention relates to a rubber composition which comprises:
a highly saturated diene elastomer which is a copolymer of ethylene and of a 1,3-diene which comprises ethylene units which represent more than 50 mol % of the monomer units of the copolymer,
a vulcanization system,
a silane coupling agent,
and a reinforcing filler which contains a silica made hydrophobic, before its use in the rubber composition, by treatment with a blocked or non-blocked mercaptosilane, and a hydrophilic silica.

The invention also relates to a tire which comprises a rubber composition in accordance with the invention, preferentially in its tread.

### DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The abbreviation “phr” means parts by weight per hundred parts of elastomer (of the total of the elastomers if several elastomers are present).

The compounds mentioned in the description can be of fossil origin or be biobased. In the latter case, they can, partially or completely, result from biomass or be obtained from renewable starting materials resulting from biomass. In the same way, the compounds mentioned can also originate from the recycling of pre-used materials, that is to say that they can, partially or completely, result from a recycling process, or else be obtained from starting materials which themselves result from a recycling process.

In the present invention, the term “tyre” is understood to mean a pneumatic or non-pneumatic tire. A pneumatic tire usually comprises two beads intended to come into contact with a rim, a crown composed of at least one crown reinforcement and a tread, two sidewalls, the tire being reinforced by a carcass reinforcement anchored in the two beads. A non-pneumatic tire, for its part, usually comprises a base, designed for example for mounting on a rigid rim, a crown reinforcement, ensuring the connection with a tread and a deformable structure, such as spokes, ribs or cells, this structure being placed between the base and the crown. Such non-pneumatic tires do not necessarily include a sidewall. Non-pneumatic tires are described, for example, in WO 03/018332 and FR 2898077. According to any one of the embodiments of the invention, the tire according to the invention is preferentially a pneumatic tire.

Unless otherwise indicated, the contents of the units resulting from the insertion of a monomer into a copolymer such as the copolymer of use in the invention are expressed as molar percentage relative to all of the monomer units of the copolymer.

The elastomer that is useful for the purposes of the invention is a highly saturated diene elastomer, which is preferably statistical, which comprises ethylene units resulting from the polymerization of ethylene. In a known manner, the expression “ethylene unit” refers to the —(CH₂—CH₂)— unit resulting from the insertion of ethylene into the elastomer chain. The highly saturated diene elastomer is rich in ethylene units, since the ethylene units represent more than 50 mol % of all of the monomer units of the elastomer.

Preferably, the highly saturated diene elastomer comprises at least 60 mol % of ethylene units, preferentially at least 65 mol % of ethylene units, more preferentially at least 70 mol % of ethylene units. In other words, the ethylene units in the highly saturated diene elastomer preferentially represent at least 60 mol % of all of the monomer units of the highly saturated diene elastomer, more preferentially at least 65 mol % of all of the monomer units of the highly unsaturated diene elastomer. Even more preferentially, the ethylene units represent at least 70 mol % of all of the monomer units of the highly saturated diene elastomer.

Preferably, the ethylene units in the highly saturated diene elastomer represent at most 90 mol % of all of the monomer units of the highly saturated diene elastomer. More preferentially, the ethylene units represent at most 85 mol % of all of the monomer units of the highly saturated diene elastomer. Even more preferentially, the ethylene units represent at most 80 mol % of all of the monomer units of the highly saturated diene elastomer.

According to one advantageous embodiment, the highly saturated diene elastomer comprises from 60 mol % to 90 mol % of ethylene units, particularly from 60 mol % to 85 mol % of ethylene units, the molar percentage being calculated on the basis of all of the monomer units of the highly saturated diene elastomer. More advantageously, the highly saturated diene elastomer comprises from 60 mol % to 80 mol % of ethylene units, the molar percentage being calculated on the basis of all of the monomer units of the highly saturated diene elastomer.

According to another advantageous embodiment, the highly saturated diene elastomer comprises from 65 mol % to 90 mol % of ethylene units, particularly from 65 mol % to 85 mol % of ethylene units, the molar percentage being calculated on the basis of all of the monomer units of the highly saturated diene elastomer. More advantageously, the highly saturated diene elastomer comprises from 65 mol % to 80 mol % of ethylene units, the molar percentage being calculated on the basis of all of the monomer units of the highly saturated diene elastomer.

According to yet another advantageous embodiment of the invention, the highly saturated diene elastomer comprises from 70 mol % to 90 mol % of ethylene units, particularly from 70 mol % to 85 mol % of ethylene units, the molar percentage being calculated on the basis of all of the monomer units of the highly saturated diene elastomer. More advantageously, the highly saturated diene elastomer comprises from 70 mol % to 80 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the term “1,3-diene unit” or “diene unit” refers to units resulting from the insertion of the 1,3-diene via a 1,4 addition, a 1,2 addition or a 3,4 addition in the case of isoprene for example. The 1,3-diene units are those, for example, of a 1,3-diene containing 4 to 12 carbon atoms, such as 1,3-butadiene, isoprene, 1,3-pentadiene or an aryl-1,3-butadiene. Preferably the 1,3-diene is 1,3-butadiene or a mixture of 1,3-dienes, one of which is 1,3-butadiene. More preferentially, the 1,3-diene is 1,3-butadiene, in which case the highly saturated diene elastomer is a copolymer of ethylene and of 1,3-butadiene, which is preferably statistical.

The highly saturated diene elastomer can be obtained according to various synthesis methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the applicant. The highly saturated diene elastomer, including when it is a statistical polymer, may also be prepared via a process using a catalytic system of preformed type such as those described in documents WO 2017093654 A1, WO 2018020122 A1 and WO 2018020123 A1.

Advantageously, the diene elastomer is a statistical polymer and is preferentially prepared according to a semi-continuous or continuous process as described in documents WO 2017103543 A1, WO 201713544 A1, WO 2018193193 and WO 2018193194.

The highly saturated diene elastomer preferably contains units of formula (I) or units of formula (II).

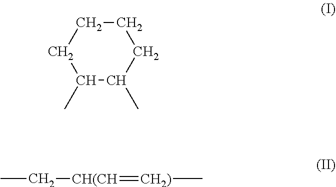

The presence of a saturated 6-membered ring unit, 1,2-cyclohexanediyl, of formula (I) in the copolymer may result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1) or the equation (eq. 2), o and p being calculated on the basis of all of the monomer units of the highly saturated diene elastomer.

$$\\ \begin{matrix}0 < o + p \leq 30 & ( eq . 1 )\end{matrix}$$

$$\\ \begin{matrix}0 < o + p < 25 & ( eq . 2 )\end{matrix}$$

Preferably, the highly saturated diene elastomer comprises units of formula (I) in a molar content greater than 0 mol % and less than 15 mol %, more preferentially less than 10 mol %, the molar percentage being calculated on the basis of all of the monomer units of the highly saturated diene elastomer.

The rubber composition can contain, in addition to the highly saturated diene elastomer, a second diene elastomer. Diene elastomer is understood to mean an elastomer composed at least in part (i.e., a homopolymer or a copolymer) of diene monomer units (monomers bearing two conjugated or non-conjugated carbon-carbon double bonds). The second elastomer can be selected from the group of highly unsaturated diene elastomers consisting of polybutadienes, polyisoprenes, butadiene copolymers, isoprene copolymers and a mixture thereof. A highly unsaturated elastomer refers to an elastomer which contains more than 50 mol % of diene units.

Preferably, the content of the highly saturated diene elastomer in the rubber composition is at least 50 parts by weight per hundred parts of elastomer of the rubber composition (phr). More preferentially, the content of the highly saturated diene elastomer in the rubber composition varies in a range extending from 80 to 100 phr. Even more preferentially, it varies in a range extending from 90 to 100 phr. It is advantageously 100 phr. The highly saturated diene elastomer can be a single highly saturated diene elastomer or a mixture of several highly saturated diene elastomers that differ from each other by their microstructures or macrostructures. In the case where the rubber composition contains several highly saturated diene elastomers which differ from one another in their microstructures or macrostructures, the content of the highly saturated diene elastomer in the rubber composition refers to the mixture of highly saturated diene elastomers.

The reinforcing filler of the rubber composition in accordance with the invention has the feature of comprising two different types of silica which differ from one another in terms of their surface chemistry, since one is a hydrophilic silica and the other is a silica made hydrophobic beforehand, i.e. made hydrophobic before its use in the rubber composition.

As is known, a silica that is made hydrophobic is a silica which has undergone a treatment that consists in modifying the surface chemistry of the silica with a modifying agent in order to make it less hydrophilic. The most well-known modifying agents are typically alkylsilanes, alkoxysilanes or silazanes ou else blocked or non-blocked mercaptosilanes. The alkoxysilanes or mercaptosilanes known as modifying agents may be the same compounds as those used as coupling agents in the rubber compositions. Reference may for example be made to patent application WO 2006110424 A1.

The silica of use for the purposes of the invention is a silica made hydrophobic beforehand, since the surface chemistry of the silica is modified before being used in the rubber composition according to the invention. The silica is made hydrophobic beforehand by treatment with a mercaptosilane, which treatment makes it possible to graft thiol functions to the surface of the silica, it being possible for the thiol functions to be blocked or non-blocked. A mercaptosilane of which the thiol function is blocked is termed blocked mercaptosilane. The treatment of the silica can be carried out according to the process described in patent application WO 2006110424 A1.

The silica made hydrophobic beforehand may be any silica which, after it has been modified with a blocked or non-blocked mercaptosilane, has a BET specific surface area or a CTAB specific surface area of less than 450 m²/g, preferably within a range extending from 30 to 400 m²/g, in particular from 60 to 300 m²/g. Alternatively, the silica made hydrophobic beforehand may be any silica modified with a blocked or non-blocked mercaptosilane, starting from a silica having a BET specific surface area or a CTAB specific surface area of less than 450 m²/g, preferably within a range extending from 30 to 400 m²/g, in particular from 60 to 300 m²/g.

In the present disclosure, the BET specific surface area is determined by gas adsorption using the Brunauer-Emmett-Teller method described in “The Journal of the American Chemical Society”, (vol. 60, page 309, February 1938), and more specifically according to a method derived from Standard NF ISO 5794-1, appendix E, of June 2010 [multipoint (5 point) volumetric method—gas: nitrogen—degassing under vacuum: one hour at 160° C.—relative pressure p/po range: 0.05 to 0.17]. The CTAB specific surface area values were determined according to Standard NF ISO 5794-1, Appendix G of June 2010. The process is based on the adsorption of CTAB (N-hexadecyl-N,N,N-trimethylammonium bromide) on the “outer” surface of the reinforcing filler.

The silica made hydrophobic beforehand is preferentially a precipitated silica made hydrophobic beforehand, more preferentially a highly dispersible (called “HDS” for “highly dispersible” or “highly dispersible silica”) precipitated silica made hydrophobic beforehand. These precipitated silicas, which may or may not be highly dispersible, and are made hydrophobic before their use in a rubber composition are well known to those skilled in the art. Mention may be made, for example, of the commercial silicas of the company PPG under the trade names “Agilon” and “Ciptane”, such as “Agilon 400” silica, “Ciptane I” silica and “Ciptane LP” silica.

Preferably, the mercaptosilane is a compound which has an alkoxysilyl or halosilyl function, preferably an alkoxysilyl function, and a thiol function, which is blocked or non-blocked. In a known manner, an alkoxysilyl function is a group comprising a silicon atom covalently bonded to an alkoxy group. Also in a known manner, a halosilyl function is a group comprising a silicon atom covalently bonded to a halogen atom.

According to a first variant, the mercaptosilane is of formula (1)

HS—R—Si(L)ₙ(Q)₃₋ₙ (1)

L being halogen or OR′, preferentially OR′, Q being hydrogen, an alkyl having 1 to 12 carbon atoms or an alkyl substituted with a halogen atom, having 1 to 12 carbon atoms, preferentially methyl or ethyl, R being an alkylene having 1 to 12 carbon atoms, preferentially methylene or propylene, R′ being an alkyl having 1 to 12 carbon atoms or an alkoxyalkyl having 2 to 12 carbon atoms, preferentially methoxy or ethoxy, said halogen being chlorine, bromine, iodine or fluorine, and n being equal to 1, 2 or 3, preferentially 3.

For example, mention may be made of mercaptomethyltrimethoxysilane, mercaptoethyltrimethoxysilane, mercaptopropyltrimethoxysilane, mercaptomethyltriethoxysilane, mercaptoethyltripropoxysilane, mercaptopropyltriethoxysilane, (mercaptomethyl)dimethylethoxysilane, (mercaptomethyl)methyldiethoxysilane, 3-mercaptopropylmethyldimethoxysilane, a mixture of these compounds. The mercaptosilane is advantageously mercaptopropyltriethoxysilane or mercaptomethyltriethoxysilane.

According to a second variant, the thiol function of the mercaptosilane is blocked with an acyl group. According to this variant, it is preferentially of formula (1) in which the hydrogen atom covalently bonded to the sulfur atom is replaced with an acyl group. The acyl group is preferentially a group of formula R⁰C(═O)—, R⁰ being alkyl, more preferentially n-alkyl having 2 to 12 carbon atoms, even more preferentially n-alkyl having 6 to 8 carbon atoms. As blocked mercaptosilanes that may be suitable, mention may be made of thiol compounds blocked with an acyl group, such as mercaptomethyltrimethoxysilane, mercaptoethyltrimethoxysilane, mercaptopropyltrimethoxysilane, mercaptomethyltriethoxysilane, mercaptoethyltripropoxysilane, mercaptopropyltriethoxysilane, (mercaptomethyl)dimethylethoxysilane, (mercaptomethyl)methyldiethoxysilane, 3-mercaptopropylmethyldimethoxysilane blocked with an acyl group, and also the mixture of these blocked thiol compounds. The acyl group is preferentially the octanoyl group CH₃(CH₂)₆C(O)—. The blocked mercaptosilane is advantageously 3-(octanoylthio)propyltriethoxysilane.

At the surface of the silica made hydrophobic beforehand, the content by mass of thiol functions (SH) or of thiol function equivalent in the case of a blocked mercaptosilane is within a range preferentially extending from 0.1 to 1%, more preferentially from 0.4 to 1%, even more preferentially from 0.4 to 0.6%, percentage by mass relative to the mass of the silica made hydrophobic beforehand.

The silica made hydrophobic beforehand preferentially has a CTAB specific surface area ranging from 100 to 200 m²/g, more preferentially from 120 to 160 m²/g.

As opposed to a silica made hydrophobic, a hydrophilic silica is, as is known, a silica for which the surface chemistry has not been modified prior to the use thereof by reaction of the hydroxyls at its surface to make it less hydrophilic. As hydrophilic silica, use may be made of any type of precipitated silica, in particular highly dispersible precipitated silicas (referred to as “HDS” for “highly dispersible” or “highly dispersible silica”). These precipitated silicas, which may or may not be highly dispersible, are well known to a person skilled in the art. The hydrophilic silica may be any hydrophilic silica having a BET specific surface area or a CTAB specific surface area of less than 450 m²/g, preferably within a range extending from 30 to 400 m²/g, in particular from 60 to 300 m²/g. Mention may for example be made of the silicas described in applications WO 03/016215-A1 and WO 03/016387-A1. Among the commercial HDS silicas, use may in particular be made of the Ultrasil® 5000GR and Ultrasil® 7000GR silicas from Evonik and the Zeosil® 1085GR, Zeosil® 1115 MP, Zeosil® 1165MP, Zeosil® Premium 200MP and Zeosil® HRS 1200 MP silicas from Solvay. As non-HDS silica, the following commercial silicas may be used: the Ultrasil® VN2GR and Ultrasil® VN3GR silicas from Evonik, the Zeosil® 175GR silica from Solvay and the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The hydrophilic silica preferentially has a CTAB ranging from 120 m²/g to 200 m²/g, more preferentially a CTAB ranging from 140 m²/g to 200 m²/g.

Preferably, the hydrophilic silica has a CTAB greater than that of the silica made hydrophobic beforehand.

The hydrophilic silica is present in the rubber composition at a weight content which is preferentially greater than or equal to 50% of the total weight of the hydrophilic silica and the silica made hydrophobic beforehand.

The reinforcing filler may comprise any type of “reinforcing” filler other than silica made hydrophobic beforehand and hydrophilic silica, known for its capacity to reinforce a rubber composition which can be used in particular for the manufacture of tires, for example a carbon black. Suitable carbon blacks include all carbon blacks, notably the blacks conventionally used in tires or their treads. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used. When carbon black is used in the rubber composition, it is preferably used in a content of less than or equal to 10 phr (for example, the carbon black content may be within a range extending from 1 to 10 phr). Advantageously, the carbon black content in the rubber composition is less than or equal to 5 phr. Within the intervals indicated, the colouring properties (black pigmenting agent) and UV-stabilizing properties of the carbon blacks are beneficial, without, moreover, adversely affecting the typical performance qualities contributed by the silica.

The silica made hydrophobic beforehand and the hydrophilic silica preferentially represent more than 50% by mass of the reinforcing filler. In other words, the total amount of silica made hydrophobic beforehand and of hydrophilic silica in the reinforcing filler is greater than 50% by weight of the total weight of the reinforcing filler. More preferentially, the silica made hydrophobic beforehand and the hydrophilic silica represent more than 85% by mass of the reinforcing filler.

The total content of reinforcing filler may vary over a wide range, for example from 30 phr to 150 phr. According to a first embodiment, the total content of reinforcing filler varies within a range extending from 30 phr to 60 phr. According to a second embodiment, the total content of reinforcing filler varies within a range extending from more than 60 phr to 150 phr. The first embodiment is preferred to the second embodiment for use of the rubber composition in a tread having a very low rolling resistance. Any one of these ranges of total content of reinforcing filler can apply to any one of the embodiments of the invention.

In order to couple the hydrophilic silica to the diene elastomer, use is made, in a well-known manner, of a coupling agent (or bonding agent), a silane, which is at least bifunctional and is intended to provide a satisfactory connection, of chemical and/or physical nature, between the hydrophilic silica and the diene elastomer during the preparation of the rubber composition. Use is in particular made of bifunctional organosilanes or polyorganosiloxanes. The term “bifunctional” is understood to mean a compound having a first functional group capable of interacting with the inorganic filler and a second functional group capable of interacting with the elastomer, preferably diene elastomer. For example, such a bifunctional compound may comprise a first functional group comprising a silicon atom, said first functional group being capable of interacting with the hydroxyl groups of the hydrophilic silica, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik or bis(triethoxysilylpropyl) disulfide, abbreviated to TESPD, sold under the name Si75 by Evonik, and polyorganosiloxanes. More preferentially, the organosilane is an organosilane polysulfide, also denoted hereinbelow under the term silane polysulfide.

The organosilane polysulfides, referred to as “symmetrical” or “asymmetrical” depending on their specific structure and also denoted hereinbelow under the name silane polysulfides, are for example described in applications WO03/002648 (or US 2005/016651) and WO03/002649 (or US 2005/016650). Suitable in particular, without the definition below being limiting, are silanes polysulfides corresponding to the general formula (2)

Z-A¹-Sₓ-A¹-Z (2)

in which:
x is an integer from 2 to 8, preferably from 2 to 5;
the A¹ symbols, which are identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);
the Z symbols, which are identical or different, correspond to one of the three formulae below:

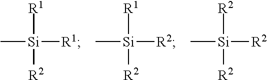

in which
the R¹ radicals, which are substituted or unsubstituted and identical to or different from one another, represent a C₁-C₁₈ alkyl group, C₅-C₁₈ cycloalkyl group or C₆-C₁₈ aryl group (preferably C₁-C₆ alkyl groups, cyclohexyl or phenyl groups, especially C₁-C₄ alkyl groups, more particularly methyl and/or ethyl),
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferentially still a group selected from C₁-C₄ alkoxyls, in particular methoxyl and ethoxyl).

In the case of a mixture of alkoxysilanes polysulfides corresponding to formula (2) above, especially standard commercially available mixtures, the average value of the “x” subscripts is a fractional number preferably of between 2 and 5, more preferentially of approximately 4.

Mention will more particularly be made, as examples of silane polysulfides, of bis((C₁-C₄)alkoxyl(C₁-C₄)alkylsilyl(C₁-C₄)alkyl)) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂. The Cₙ-Cₘ the nomination describing a group refers to the number of carbon atoms making up the group, which contains n to m carbon atoms, n and m being integers with m greater than n.

Among the silane polysulfides which are suitable, mention may also be made of hydroxysilane polysulfides, for example described in patent application WO 02/31041 (or US 2004/051210).

The bifunctional POSs (polyorganosiloxanes) are for example described in patent application WO 02/30939 (or U.S. Pat. No. 6,774,255).

In the rubber composition in accordance with the invention, the content of silane coupling agent is adjusted by those skilled in the art depending on the chemical structure of the coupling agent, depending on the specific surface area of the hydrophilic silica used in the rubber composition and depending on the content of hydrophilic silica in the rubber composition. It is preferentially within a range extending from 1 to 15 phr, more preferentially from 1.5 to 10 phr, even more preferentially from 2 to 5 phr.

Preferably, the silane coupling agent is a silane polysulfide corresponding to the general formula (2).

Another essential feature of the rubber composition in accordance with the invention is that of containing a vulcanization system, that is to say a sulfur-based crosslinking system. The sulfur is typically provided in the form of molecular sulfur or of a sulfur-donating agent, preferably in molecular form. Sulfur in molecular form is also referred to by the term “molecular sulfur”. The term “sulfur donor” means any compound which releases sulfur atoms, optionally combined in the form of a polysulfide chain, which are capable of inserting into the polysulfide chains formed during the vulcanization and bridging the elastomer chains. Various known secondary vulcanization accelerators or vulcanization activators, such as zinc oxide, stearic acid, guanidine derivatives (in particular diphenylguanidine), and the like, are added to the vulcanization system, being incorporated during the first non-productive phase and/or during the productive phase. The sulfur content is preferably between 0.5 and 4 phr and the content of the primary accelerator is preferably between 0.5 and 5 phr. These preferential contents may apply to any one of the embodiments of the invention.

Use may be made, as (primary or secondary) vulcanization accelerator, of any compound that is capable of acting as accelerator of the vulcanization of the diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators. As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide. As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

The vulcanization is performed in a known manner at a temperature generally of between 130° C. and 200° C., for a sufficient time which may range, for example, between 5 and 90 min, as a function especially of the curing temperature, of the vulcanization system adopted and of the vulcanization kinetics of the composition under consideration.

The rubber composition in accordance with the invention may also comprise all or some of the usual additives generally used in elastomer compositions intended for the manufacture of tires, in particular pigments, protective agents such as anti-ozone waxes, chemical anti-ozonants, antioxidants, and plasticizers such as plasticizing oils or resins.

The rubber composition, before vulcanization, may be manufactured in appropriate mixers, using two successive phases of preparation according to a procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first (non-productive) phase is carried out in a single thermomechanical step during which all the necessary constituents, the optional supplementary processing aids and various other additives, with the exception of the vulcanization system, are introduced into an appropriate mixer, such as an ordinary internal mixer. The total duration of the kneading, in this non-productive phase, is preferably of between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The rubber composition can be calendered or extruded in the form of a sheet or of a slab, in particular for a laboratory characterization, or also in the form of a rubber semi-finished product (or profiled element) which can be used in a tire. The composition can be either in the green state (before crosslinking or vulcanization) or in the cured state (after crosslinking or vulcanization). It may constitute all or part of a semi-finished article, in particular intended to be used in a pneumatic or non-pneumatic tire which comprises a tread, in particular in the tire tread.

To sum up, the invention is advantageously implemented according to any one of the following embodiments 1 to 32:

Embodiment 1: Rubber composition which comprises:
a highly saturated diene elastomer which is a copolymer of ethylene and of a 1,3-diene which comprises ethylene units which represent more than 50 mol % of the monomer units of the copolymer,
a vulcanization system,
a silane coupling agent,
and a reinforcing filler which contains a silica made hydrophobic, before its use in the rubber composition, by treatment with a blocked or non-blocked mercaptosilane, and a hydrophilic silica.

Embodiment 2: Rubber composition according to embodiment 1, in which the 1,3-diene is 1,3-butadiene or a mixture of 1,3-dienes, one of which is 1,3-butadiene.

Embodiment 3: Rubber composition according to embodiment 1 or 2, in which the 1,3-diene is 1,3-butadiene.

Embodiment 4: Rubber composition according to any one of embodiments 1 to 3, in which the ethylene units in the highly saturated diene elastomer represent at least 60 mol % of all of the monomer units of the highly saturated diene elastomer.

Embodiment 5: Rubber composition according to any one of embodiments 1 to 4, in which the ethylene units in the highly saturated diene elastomer represent at least 65 mol % of all of the monomer units of the highly saturated diene elastomer.

Embodiment 6: Rubber composition according to any one of embodiments 1 to 5, in which the ethylene units in the highly saturated diene elastomer represent at least 70 mol % of all of the monomer units of the highly saturated diene elastomer.

Embodiment 7: Rubber composition according to any one of embodiments 1 to 6, in which the ethylene units in the highly saturated diene elastomer represent at most 90 mol % of all of the monomer units of the highly saturated diene elastomer.

Embodiment 8: Rubber composition according to any one of embodiments 1 to 7, in which the ethylene units in the highly saturated diene elastomer represent at most 85 mol % of all of the monomer units of the highly saturated diene elastomer.

Embodiment 9: Rubber composition according to any one of embodiments 1 to 8, in which the ethylene units in the highly saturated diene elastomer represent at most 80 mol % of all of the monomer units of the highly saturated diene elastomer.

Embodiment 10: Rubber composition according to any one of embodiments 1 to 9, in which the highly saturated diene elastomer is a statistical copolymer.

Embodiment 11: Rubber composition according to any one of embodiments 1 to 10, in which the highly saturated diene elastomer contains units of formula (1) or units of formula (II).

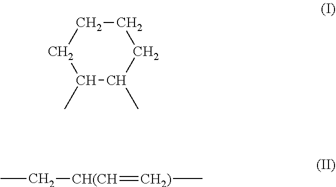

Embodiment 12: Rubber composition according to any one of embodiments 1 to 11, in which the highly saturated diene elastomer comprises units of formula (1) in a molar content greater than 0% and less than 15%.

Embodiment 13: Rubber composition according to any one of embodiments 1 to 12, in which the content of highly saturated diene elastomer is at least 50 parts by weight per hundred parts of elastomer, phr, of the rubber composition.

Embodiment 14: Rubber composition according to any one of embodiments 1 to 13, in which the content of highly saturated diene elastomer varies within a range extending from 80 to 100 phr.

Embodiment 15: Rubber composition according to any one of embodiments 1 to 14, in which the silica made hydrophobic beforehand is a precipitated silica made hydrophobic beforehand.

Embodiment 16: Rubber composition according to any one of embodiments 1 to 15, in which the mercaptosilane is a compound that has an alkoxysilyl or halosilyl function and a blocked or non-blocked thiol function.

Embodiment 17: Rubber composition according to any one of embodiments 1 to 16, in which the mercaptosilane is of formula (1)

HS—R—Si(L)ₙ(Q)₃₋ₙ (1),

L being halogen or —OR′, Q being hydrogen, an alkyl having 1 to 12 carbon atoms or an alkyl substituted with a halogen atom, having 1 to 12 carbon atoms, R being an alkylene having 1 to 12 carbon atoms, R′ being an alkyl having 1 to 12 carbon atoms or an alkoxyalkyl having 2 to 12 carbon atoms, said halogen being chlorine, bromine, iodine or fluorine, and n being 1, 2 or 3.

Embodiment 18: Rubber composition according to any one of embodiments 1 to 17, in which, at the surface of the silica made hydrophobic beforehand, the content by mass of thiol functions (SH) or of thiol function equivalent in the case of a blocked mercaptosilane is within a range extending from 0.1 to 1%, preferentially from 0.4 to 1%, percentage by mass relative to the mass of the silica made hydrophobic beforehand.

Embodiment 19: Rubber composition according to any one of embodiments 1 to 18, in which, at the surface of the silica made hydrophobic beforehand, the content by mass of thiol functions (SH) or of thiol function equivalent in the case of a blocked mercaptosilane is within a range extending from 0.4 to 0.6%, percentage by mass relative to the mass of the silica made hydrophobic beforehand.

Embodiment 20: Rubber composition according to any one of embodiments 1 to 19, in which the silica made hydrophobic beforehand has a CTAB specific surface area extending from 100 to 200 m²/g.

Embodiment 21: Rubber composition according to any one of embodiments 1 to 20, in which the silica made hydrophobic beforehand has a CTAB specific surface area extending from 120 to 160 m²/g.

Embodiment 22: Rubber composition according to any one of embodiments 1 to 21, in which the silica made hydrophobic beforehand and the hydrophilic silica represent more than 50% by mass of the reinforcing filler.

Embodiment 23: Rubber composition according to any one of embodiments 1 to 22, in which the silica made hydrophobic beforehand and the hydrophilic silica represent more than 85% by mass of the reinforcing filler.

Embodiment 24: Rubber composition according to any one of embodiments 1 to 23, in which the hydrophilic silica is present in a content by mass of greater than or equal to 50% of the total mass of the hydrophilic silica and the silica made hydrophobic beforehand.

Embodiment 25: Rubber composition according to any one of embodiments 1 to 24, in which the hydrophilic silica has a CTAB greater than that of the silica made hydrophobic beforehand.

Embodiment 26: Rubber composition according to any one of embodiments 1 to 25, in which the hydrophilic silica has a CTAB extending from 120 m²/g to 200 m²/g.

Embodiment 27: Rubber composition according to any one of embodiments 1 to 26, in which the total content of reinforcing filler ranges from 30 phr to 150 phr.

Embodiment 28: Rubber composition according to any one of embodiments 1 to 27, in which the hydrophilic silica has a CTAB extending from 140 m²/g to 200 m²/g.

Embodiment 29: Rubber composition according to any one of embodiments 1 to 28, in which the silane coupling agent is a silane polysulfide.

Embodiment 30: Rubber composition according to embodiment 29, in which the silane polysulfide is of formula (2)

Z-A¹-Sₓ-A¹-Z (2)

in which:
x is an integer from 2 to 8, preferably from 2 to 5;
the A¹ symbols, which are identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);
the Z symbols, which are identical or different, correspond to one of the three formulae below:

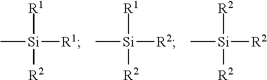

in which
the R¹ radicals, which are substituted or unsubstituted and identical to or different from one another, represent a C₁-C₁₈ alkyl group, C₅-C₁₈ cycloalkyl group or C₆-C₁₈ aryl group (preferably C₁-C₆ alkyl groups, cyclohexyl or phenyl groups, especially C₁-C₄ alkyl groups, more particularly methyl and/or ethyl),
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferentially still a group selected from C₁-C₄ alkoxyls, in particular methoxyl and ethoxyl).

Embodiment 31: tire which comprises a rubber composition defined in any one of embodiments 1 to 30.

Embodiment 32: tire which comprises a rubber composition defined in any one of embodiments 1 to 30 in its tread.

A better understanding of the abovementioned characteristics of the present invention, and also others, will be obtained on reading the following description of several implementational examples of the invention, which are given by way of illustration and without limitation.

### EXAMPLES

### Dynamic Properties

The dynamic properties G* and tan δ(max) measured on a viscosity analyser (Metravib VA4000), according to standard ASTM D 5992-96. The response of a sample of vulcanized composition (cylindrical test specimen with a thickness of 4 mm and a cross section of 400 mm²), subjected to a simple alternating sinusoidal shear stress at a frequency of 10 Hz at 60° C. is recorded. A strain amplitude sweep is performed from 0.1% to 100% (outward cycle) and then from 100% to 0.1% (return cycle). The results made use of are the complex dynamic shear modulus (G*) and the loss factor tan δ. For the return cycle, the maximum value of tan δ observed, denoted tan δ(max), is indicated.

### Vulcanization Properties:

The measurements are performed at 150° C. with an oscillating-chamber rheometer, according to the standard DIN 53529—part 3 (June 1983). The change in the rheometric torque as a function of the time describes the change in the stiffening of the composition as a result of the vulcanisation reaction. The measurements are processed according to the standard DIN 53529—part 2 (March 1983). Ti is the induction period, that is to say the time necessary for the start of the vulcanization reaction. Tα (for example T95) is the time necessary to achieve a conversion of α %, that is to say α % (for example 95%) of the difference between the minimum and maximum torques.

### Microstructure of the Elastomers by Nuclear Magnetic Resonance Analysis:

The microstructure of the elastomers is determined by ¹H NMR analysis, combined with ¹³C NMR analysis when the resolution of the ¹H NMR spectra does not enable assignment and quantification of all of the species. The measurements are carried out using a Bruker 500 MHz NMR spectrometer at frequencies of 500.43 MHz for observing protons and 125.83 MHz for observing carbons.

For the insoluble elastomers which have the ability to swell in a solvent, a 4 mm z-grade HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analyzed material and a deuterated solvent enabling swelling, generally deuterated chloroform (CDCl₃). The solvent used must always be deuterated and its chemical nature may be adapted by those skilled in the art. The amounts of material used are adjusted so as to obtain spectra of sufficient sensitivity and resolution.

The soluble samples are dissolved in a deuterated solvent (about 25 mg of elastomer in 1 ml), generally deuterated chloroform (CDCl₃). The solvent or solvent blend used must always be deuterated and its chemical nature may be adapted by those skilled in the art.

In both cases (soluble sample or swollen sample):

A 30° single pulse sequence is used for proton NMR. The spectral window is adjusted to observe all the resonance lines belonging to the molecules analysed. The accumulation number is adjusted in order to obtain a signal to noise ratio that is sufficient for the quantification of each subunit. The recycle delay between each pulse is adapted to obtain a quantitative measurement.

For the carbon NMR, a single 30° pulse sequence is used with proton decoupling only during acquisition to avoid the “nuclear Overhauser” effects (NOE) and to remain quantitative. The spectral window is adjusted to observe all the resonance lines belonging to the molecules analysed. The accumulation number is adjusted in order to obtain a signal to noise ratio that is sufficient for the quantification of each subunit. The recycle delay between each pulse is adapted to obtain a quantitative measurement.

The NMR measurements are performed at 25° C.

### Glass Transition Temperature of the Polymers:

The glass transition temperature (Tg) is measured by means of a differential scanning calorimeter according to Standard ASTM D3418 (1999).

### Mooney Viscosity:

The Mooney viscosity is measured using an oscillating consistometer as described in Standard ASTM D1646 (1999). The measurement is carried out according to the following principle: the sample, analysed in the uncured state (i.e. before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity (ML) is expressed in “Mooney unit” (MU, with 1 MU=0.83 newton·metre).

### Preparation of the Rubber Compositions:

Four rubber compositions C1 to C4 are prepared. These compositions are manufactured in the following manner:

The elastomer, then the silica or silicas, where appropriate the silane polysulfide coupling agent, and also the various other ingredients except the vulcanization system, are introduced into an internal mixer (final degree of filling: approximately 70% by volume), the initial temperature of which is approximately 80° C. Thermomechanical working (non-productive phase) is then carried out in one step, which lasts approximately 5 min to 6 min, until a maximum “dropping” temperature of 160° C. is reached. The mixture thus obtained is recovered and cooled and then sulfur and an accelerator of sulfenamide type are incorporated on a mixer (homofinisher) at 23° C., everything being mixed (productive phase) for an appropriate time (for example between 5 and 12 min).

The rubber compositions C1 to C4 all contain a highly saturated diene elastomer, the elastomer E1, a vulcanization system and a reinforcing filler comprising a silica. The rubber composition C1 is a control composition, the rubber composition C4 is a comparative composition.

Only the compositions C2 and C3 are in accordance with the invention, since the reinforcing filler contains both a hydrophilic silica and a silica made hydrophobic beforehand by treatment with a mercaptosilane. The silica in C1 is a hydrophilic silica, the silica in C4 is a silica made hydrophobic beforehand by treatment with a mercaptosilane. The content of silane polysulfide coupling agent, “Si69”, in C1 to C3 is indexed on the specific surface area (CTAB) value of the hydrophilic silica used in C1 to C3, respectively.

The formulations (in phr) of the rubber compositions C1 to C4 are described in Table 1. The compositions thus obtained are subsequently calendered, either in the form of slabs (with a thickness ranging from 2 to 3 mm) or thin sheets of rubber, for the measurement of their physical or mechanical properties after a vulcanization at 150° C. (cured state), or in the form of profiled elements which can be used directly, after cutting and/or assembling to the desired dimensions, for example as semi-finished products for tires.

The elastomer E1 is a copolymer of ethylene and of 1,3-butadiene prepared according to the following procedure:

Added to a 70 L reactor containing methylcyclohexane (64 L), ethylene (5600 g) and 1,3-butadiene (2948 g) are butyloctylmagnesium (BOMAG) in solution in methylcyclohexane and the catalytic system. The Mg/Nd ratio is 6.2. The volume of the catalytic system solution introduced is 840 ml, the concentration of the catalytic system solution in Nd being 0.0065 M. The reaction temperature is regulated at a temperature of 80° C. and the polymerization reaction starts. The polymerization reaction takes place at a constant pressure of 8.3 bar. The reactor is fed throughout the polymerization with ethylene and 1,3-butadiene in the molar proportions 73/27. The polymerization reaction is stopped by cooling, degassing of the reactor and addition of ethanol. An antioxidant is added to the polymer solution. The copolymer is recovered after steam stripping and drying to constant mass. The polymerization time is 225 minutes. The weighed mass (6.206 kg) makes it possible to determine the mean catalytic activity of the catalytic system, expressed in kilograms of polymer synthesized per mole of neodymium metal and per hour (kg/mol·h). The copolymer has an ML value equal to 62.

The catalytic system is a preformed catalytic system. It is prepared in methylcyclohexane from a metallocene, [Me₂Si(Flu)₂Nd(μ-BH₄)₂Li(THF)] at 0.0065 mol/I, a cocatalyst, butyloctylmagnesium (BOMAG), the BOMAG/Nd molar ratio of which is equal to 2.2, and a preformation monomer, 1,3-butadiene, the 1,3-butadiene/Nd molar ratio of which is equal to 90. The medium is heated at 80° C. over a period of 5 h. It is prepared according to a preparation method in accordance with section 11.1 of patent application WO 2017093654 A1.

The results of the curing properties and of the dynamic properties after curing are given in Table 2. The results are expressed in base 100 relative to a control. A value greater than that of the control, arbitrarily set at 100, indicates a measured quantity greater than that of the control.

The results show that compositions C2 and C3 are rubber compositions which have a curing time (T95) as short as composition C4 and a level of stiffness and hysteresis comparable to composition C1. By reducing the in-press curing time while maintaining the compromise of properties between stiffness and hysteresis, the combined use of a hydrophilic silica and of a silica made hydrophobic beforehand by treatment with a mercaptosilane offers the best compromise between the productivity of a tire manufacturing site and the performance of a tire in terms of wear resistance and rolling resistance.

TABLE 1

| Composition | C1 | C2 | C3 | C4 |
|---|---|---|---|---|
| E1 (1) | 100 | 100 | 100 | 100 |
| Silica (2) | | 9 | 18.5 | 37 |
| Silica (3) | 37 | 28 | 18.5 | |
| N234 (4) | 2 | 2 | 2 | 2 |
| DPG (5) | 1.2 | 1.2 | 1.2 | 1.2 |
| Coupling agent (6) | 3.0 | 2.8 | 2.6 | |
| Stearic acid (7) | 0.7 | 0.7 | 0.7 | 0.7 |
| ZnO (8) | 2.5 | 2.5 | 2.5 | 2.5 |
| 6PPD (9) | 2 | 2 | 2 | 2 |
| Ozone wax (10) | 1 | 1 | 1 | 1 |
| Sulfur | 1 | 1 | 1 | 1 |
| CBS (11) | 1 | 1 | 1 | 1 |

(1) copolymer of ethylene and of 1,3-butadiene containing 74 mol % ethylene units, 19 mol % butadiene units in the form of 1,2 and 1,4 units and 7 mol % 1,2-cyclohexanediyl units, with a Tg of −44° C.
(2) Agilon 400 from PPG, CAS 112926-00-8, CTAB 140 m²/g, thiol (-SH)-functionalized silica made hydrophobic beforehand at 0.5% by weight
(3) Zeosil 1165 MP from Solvay-Rhodia, in the form of microbeads, CTAB 160 m²/g, precipitated silica
(4) Carbon black, ASTM N234 grade
(5) Diphenylguanidine “Perkacit DPG” from Flexsys
(6) Triethoxysilylpropyltetrasulfide (TESPT) liquid silane, Si69 from Evonik
(7) Stearic acid, Pristerene 4931 from Uniqema
(8) Zinc oxide, industrial grade from Umicore
(9) N-(1,3-dimethylbutyl)-N′-phenyl-p-phenylenediamine, Santoflex 6PPD from Flexys
(10) Anti-ozone wax, Varazon 4959 from Sasol Wax
(11) N-cyclohexyl-2-benzothiazol-sulfenamide, Santocure CBS from Flexsys

TABLE 2

| Composition | C1 | C2 | C3 | C4 |
|---|---|---|---|---|
| T95 at 150° C. | 100 | 64 | 57 | 50 |
| G* 25% 60° C. | 100 | 100 | 100 | 84 |
| tanδ(max)60° C. | 100 | 104 | 100 | 107 |

What is claimed is:

1. A rubber composition which comprises:
a highly saturated diene elastomer which is a copolymer of ethylene and of a 1,3-diene which comprises ethylene units which represent more than 50 mol % of the monomer units of the copolymer,
a vulcanization system,
a silane coupling agent,
and a reinforcing filler which contains a silica made hydrophobic, before its use in the rubber composition, by treatment with a blocked or non-blocked mercaptosilane, and a hydrophilic silica.

2. The rubber composition according to claim 1, in which the 1,3-diene is 1,3-butadiene or a mixture of 1,3-dienes, one of which is 1,3-butadiene.

3. The rubber composition according to claim 1, in which the ethylene units in the highly saturated diene elastomer represent at least 60 mol % of all of the monomer units of the highly saturated diene elastomer.

4. The rubber composition according to claim 1, in which the ethylene units in the highly saturated diene elastomer represent at most 90 mol % of all of the monomer units of the highly saturated diene elastomer.

5. The rubber composition according to claim 1, in which the highly saturated diene elastomer is a statistical copolymer.

6. The rubber composition according to claim 1, in which the silica made hydrophobic beforehand and the hydrophilic silica represent more than 50% by mass of the reinforcing filler.

7. The rubber composition according to claim 1, in which the silica made hydrophobic beforehand is a precipitated silica made hydrophobic beforehand.

8. The rubber composition according to claim 1, in which the mercaptosilane is of formula HS—R—Si(L)ₙ(Q)₃₋ₙ, L being halogen or —OR′, Q being hydrogen, an alkyl having 1 to 12 carbon atoms or an alkyl substituted with a halogen atom, having 1 to 12 carbon atoms, R being an alkylene having 1 to 12 carbon atoms, R′ being an alkyl having 1 to 12 carbon atoms or an alkoxyalkyl having 2 to 12 carbon atoms, said halogen being chlorine, bromine, iodine or fluorine, and n being 1, 2 or 3.

9. The rubber composition according to claim 1, in which, at the surface of the silica made hydrophobic beforehand, the content by mass of thiol functions (SH) or of thiol function equivalent in the case of a blocked mercaptosilane is within a range extending from 0.1 to 1%, percentage by mass relative to the mass of the silica made hydrophobic beforehand.

10. The rubber composition according to claim 1, in which the silica made hydrophobic beforehand has a CTAB specific surface area extending from 100 to 200 m²/g.

11. The rubber composition according to claim 1, in which the hydrophilic silica is present in a content by mass of greater than or equal to 50% of the total mass of the hydrophilic silica and the silica made hydrophobic beforehand.

12. The rubber composition according to claim 1, in which the hydrophilic silica has a CTAB greater than that of the silica made hydrophobic beforehand.

13. The rubber composition according to claim 1, in which the hydrophilic silica has a CTAB extending from 120 m²/g to 200 m²/g.

14. The rubber composition according to claim 1, in which the silane coupling agent is a silane polysulfide.

15. A tire which comprises a rubber composition defined in claim 1.

16. The rubber composition according to claim 2, in which the 1,3-diene includes 1,3-butadiene.

17. The rubber composition according to claim 3, in which the ethylene units in the highly saturated diene elastomer represent at least 70 mol % of all of the monomer units of the highly saturated diene elastomer.

18. The rubber composition according to claim 4, in which the ethylene units in the highly saturated diene elastomer represent at most 80 mol % of all of the monomer units of the highly saturated diene elastomer.

19. The rubber composition according to claim 6, in which the silica made hydrophobic beforehand and the hydrophilic silica represent more than 85% by mass of the reinforcing filler.

20. The rubber composition according to claim 9, in which the content by mass of thiol functions (SH) or of thiol function equivalent in the case of a blocked mercaptosilane is within a range extending from 0.4 to 0.6%, percentage by mass relative to the mass of the silica made hydrophobic beforehand.
